(19) United States
(12) Patent Application Publication
(10) Pub. No.: US 2018/0272411 A1
(43) Pub. Date: Sep. 27, 2018

(54) BONDING METHOD, AND METHOD OF MANUFACTURING DIFFERENT-MATERIAL BONDED BODY

(71) Applicant: Kabushiki Kaisha Kobe Seiko Sho (Kobe Steel, Ltd.), Hyogo (JP)

(72) Inventors: Hideto KATSUMA, Kobe-shi, Hyogo (JP); Jiro IWAYA, Nagoya-shi, Aichi (JP); Junya NAITOU, Kobe-shi, Hyogo (JP); Yasuhiro MAEDA, Kobe-shi, Hyogo (JP); Toru HASHIMURA, Kobe-shi, Hyogo (JP); Ryohei YUKISHIGE, Kobe-shi, Hyogo (JP)

(73) Assignee: Kabushiki Kaisha Kobe Seiko Sho (Kobe Steel, Ltd.), Hyogo (JP)

(21) Appl. No.: 15/763,415

(22) PCT Filed: Sep. 26, 2016
(86) PCT No.: PCT/JP2016/078182

§ 371 Date: Mar. 26, 2018

(30) Foreign Application Priority Data
Sep. 28, 2015 (JP) 2015-189824

(51) Int. Cl. B21D 47/04; B21D 22/22; B23K 11/11; B23K 11/20

(52) U.S. Cl. CPC B21D 47/04; B21D 22/22; B21D 24/04; B23K 11/20; B23K 11/11

(57) ABSTRACT

A method of bonding a first frame member and a second frame member includes: a protrusion formation step of forming a protrusion in a predetermined region of a plate by press fabrication; a stacking step of producing such a stack body of flanges and the plate that a leading end of the protrusion of the plate contacts with the flange and the flange is disposed between the flange and the plate; and a welding step of welding the protrusion to the flange by applying welding current between a pair of electrodes while the stack body is sandwiched between the pair of electrodes so that the protrusion is pressed against the flange.

### TECHNICAL FIELD

The present invention relates to a method of bonding two kinds of metal members made of materials different from each other at an overlapping part and a method of manufacturing a different-material bonded body.

### BACKGROUND ART

Patent Document 1 discloses a bonding method of spot-welding a circular blank to a steel plate by applying welding current between a pair of electrodes while a stack body in which an AL alloy plate is sandwiched between the steel plate and the circular blank is pressurized by the pair of electrodes, the steel plate and the circular blank having melting points higher than that of the alloy plate. In this bonding method, a bulging deformation part formed due to plastic deformation at a central part of the circular blank under the pressurization and current application by the pair of electrodes removes a melting part of the alloy plate and is spot-welded to the steel plate. In this manner, the alloy plate and the steel plate, which are made of materials different from each other, are bonded together at an overlapping part.

### PRIOR ART DOCUMENT

### Patent Document

Patent Document 1: Japanese Patent No. 3400207

### SUMMARY OF THE INVENTION

### Problems to be Solved by the Invention

However, in the above-described bonding method disclosed in Patent Document 1, since the bulging deformation part is formed by simply pressing the circular blank with the electrodes, wrinkles are formed near the bulging deformation part of the circular blank at bulging deformation part formation. In addition, the bulging deformation part of the circular blank does not have a stable protrusion shape because the electrodes are unlikely to sufficiently fit the circular blank and thus bumps are likely to be formed. Accordingly, when the bulging deformation part of the circular blank is welded to the steel plate, space remains between the steel plate and the different material member, and thus sputtering is likely to occur. This leads to degraded welding quality and reduced bonding strength. In addition, since the electrodes are used to form the bulging deformation part by pressing, the electrodes suffer large abrasion. Thus, difference in shape occurs between bulging deformation parts thus formed, and the quality of welding to the steel plate varies between the bulging deformation parts. In addition, since the electrodes suffer large abrasion, the electrodes have short lifetimes. Such degradation and variance of the welding quality cause reduction and variance of the bonding strength of the overlapping part between the alloy plate and the steel plate, which are made of materials different from each other, and also reduction of the lifetimes of the electrodes.

The present invention is intended to provide a bonding method and a method of manufacturing a different-material bonded body, which are capable of achieving improved and stabilized bonding strength of an overlapping part between a first metal member and a second metal member made of materials different from each other, and long lifetimes of electrodes.

### Solutions to the Problems

A bonding method according to an aspect of the present invention is a method of bonding a first metal member and a second metal member made of a material different from a material of the first metal member at an overlapping part. The method includes: a protrusion formation step of forming at least one protrusion in a third metal member made of a material same as the material of the first metal member by pressing a predetermined region of at least the third metal member among the first metal member and the third metal member with a punch while circumference of the predetermined region is sandwiched between a die and a blank holder; a stacking step of producing such a stack body of the first, second, and third metal members that a leading end of the protrusion of the third metal member formed through the protrusion formation step contacts with the first metal member and the second metal member is disposed between the first metal member and the third metal member; and a welding step of welding the protrusion to the first metal member by applying welding current between a pair of electrodes while the stack body produced through the stacking step is sandwiched between the pair of electrodes in a stacking direction of the stack body so that the protrusion is pressed against the first metal member.

With this configuration, the first metal member and the third metal member are welded through the protrusion while the second metal member is sandwiched between the first metal member and the third metal member. Accordingly, the first metal member and the second metal member, which are made of materials different from each other, are bonded together at the overlapping part. Since the at least one protrusion is formed in advance through the protrusion formation step in the bonding method, wrinkles are unlikely to be formed in the metal members at protrusion formation. Thus, sputtering is unlikely to occur when the protrusion is welded to the first metal member, thereby achieving improved welding quality and improved bonding strength. Since the at least one protrusion formed in the third metal member in advance is welded to the first metal member by applying welding current between the pair of electrodes while the protrusion contacts with the first metal member, there is no need to form the protrusion with the electrodes, and thus the electrodes have longer lifetimes and error is unlikely to occur in shaping of the protrusion, which leads to stabilized welding quality. Since the welding quality is improved and stabilized in this manner, the bonding strength of the overlapping part between the first and second metal members made of materials different from each other is improved and stabilized, which leads to longer lifetimes of the electrodes.

According to an aspect of the present invention, the method further includes a through-hole formation step of forming, in a predetermined region of the second metal member, at least one through-hole having a size that allows insertion of the at least one protrusion. It is preferable that, in the stacking step, the first, second, and third metal members are stacked while the at least one protrusion is inserted in the through-hole. With this configuration, the first and second metal members made of materials different from each other are more solidly bonded together at the overlapping part.

According to an aspect of the present invention, it is preferable that, in the through-hole formation step, the through-hole is formed by punching the predetermined region of the second metal member with a punch while circumference of the predetermined region is sandwiched between a die and a blank holder. With this configuration, burrs are unlikely to be formed in the second metal member at through-hole formation. Accordingly, the first and second metal members made of materials different from each other are further solidly bonded together at the overlapping part.

According to an aspect of the present invention, it is preferable that, in the welding step, welding current is applied between the pair of electrodes while the protrusion and a region of the first metal member facing to the protrusion are sandwiched between the pair of electrodes. With this configuration, the quality of welding the protrusion formed in the third metal member to the first metal member is further improved.

According to an aspect of the present invention, it is preferable that a plurality of the protrusions are formed in the third metal member in the protrusion formation step, and welding current is applied between the pair of electrodes while the plurality of the protrusions and regions of the first metal member facing to the plurality of the protrusions are sandwiched between the pair of electrodes in the welding step. With this configuration, the plurality of the protrusions formed in the third metal member can be effectively welded to the first metal member.

A method of manufacturing a different-material bonded body according to an aspect of the present invention is a method of manufacturing a different-material bonded body in which a first metal member is placed over and bonded with a second metal member made of a material different from a material of the first metal member. The method includes: a protrusion formation step of forming at least one protrusion in a third metal member made of a material same as the material of the first metal member by pressing a predetermined region of at least the third metal member among the first metal member and the third metal member with a punch while circumference of the predetermined region is sandwiched between a die and a blank holder; a stacking step of producing such a stack body of the first, second, and third metal members that a leading end of the protrusion of the third metal member formed through the protrusion formation step contacts with the first metal member and the second metal member is disposed between the first metal member and the third metal member; and a welding step of welding the protrusion to the first metal member by applying welding current between a pair of electrodes while the stack body produced through the stacking step is sandwiched between the pair of electrodes in a stacking direction of the stack body so that the protrusion is pressed against the first metal member.

With this configuration, the first metal member and the third metal member are welded through the protrusion while the second metal member is sandwiched between the first metal member and the third metal member. Accordingly, the different-material bonded body is manufactured in which the first and second metal members made of materials different from each other are bonded together at the overlapping part. Since the at least one protrusion is formed in advance through the protrusion formation step in the manufacturing method, wrinkles are unlikely to be formed in the metal members at protrusion formation. Thus, sputtering is unlikely to occur when the protrusion is welded to the first metal member, thereby achieving improved welding quality and improved bonding strength. Since the at least one protrusion formed in the third metal member in advance is welded to the first metal member by applying welding current between the pair of electrodes while the protrusion contacts with the first metal member, there is no need to form the protrusion with the electrodes, and thus the electrodes have longer lifetimes and error is unlikely to occur in shaping of the protrusion, which leads to stabilized welding quality. Since the welding quality is improved and stabilized in this manner, the bonding strength of the overlapping part between the first and second metal members made of materials different from each other is improved and stabilized, which leads to longer lifetimes of the electrodes.

### Effects of the Invention

In the bonding method according to an aspect of the present invention, the first metal member and the third metal member are welded through the protrusion while the second metal member is sandwiched between the first metal member and the third metal member. Accordingly, the first metal member and the second metal member, which are made of materials different from each other, are bonded together at the overlapping part. Since the at least one protrusion is formed in advance through the protrusion formation step in the bonding method, wrinkles are unlikely to be formed in the metal members at protrusion formation. Thus, sputtering is unlikely to occur when the protrusion is welded to the first metal member, thereby achieving improved welding quality and improved bonding strength. Since the at least one protrusion formed in the third metal member in advance is welded to the first metal member by applying welding current between the pair of electrodes while the protrusion contacts with the first metal member, there is no need to form the protrusion with the electrodes, and thus the electrodes have longer lifetimes and error is unlikely to occur in shaping of the protrusion, which leads to stabilized welding quality. Since the welding quality is improved and stabilized in this manner, the bonding strength of the overlapping part between the first and second metal members made of materials different from each other is improved and stabilized, which leads to longer lifetimes of the electrodes.

In the method of manufacturing a different-material bonded body according to an aspect of the present invention, the first metal member and the third metal member are welded through the protrusion while the second metal member is sandwiched between the first metal member and the third metal member. Accordingly, the different-material bonded body is manufactured in which the first and second metal members made of materials different from each other are bonded together at the overlapping part. Since the at least one protrusion is formed in advance through the protrusion formation step in the manufacturing method, wrinkles are unlikely to be formed in the metal members at protrusion formation. Thus, sputtering is unlikely to occur when the protrusion is welded to the first metal member, thereby achieving improved welding quality and improved bonding strength. Since the at least one protrusion formed in the third metal member in advance is welded to the first metal member by applying welding current between the pair of electrodes while the protrusion contacts with the first metal member, there is no need to form the protrusion with the electrodes, and thus the electrodes have longer lifetimes and error is unlikely to occur in shaping of the protrusion, which leads to stabilized welding quality. Since the welding quality is improved and stabilized in this manner, the bonding strength of the overlapping part between the first and second metal members made of materials different from each other is improved and stabilized, which leads to longer lifetimes of the electrodes.

### BRIEF DESCRIPTION OF THE DRAWINGS

FIG. 1 is a schematic perspective view of a frame structural body in which a sub frame manufactured by a manufacturing method according to an embodiment of the present invention is employed.

FIG. 2 is a schematic perspective view of the sub frame illustrated in FIG. 1.

FIG. 3 is a cross-sectional view taken along line in FIG. 2.

FIG. 4A is a diagram illustrating a situation in which the circumference of a predetermined region of a plate illustrated in FIG. 2 is sandwiched between a die and a blank holder.

FIG. 4B is a diagram illustrating a situation in which a protrusion is formed in the predetermined region of the plate with a punch.

FIG. 5A is a diagram illustrating a situation in which the circumference of a predetermined region of a flange illustrated in FIG. 2 is sandwiched between a die and a blank holder.

FIG. 5B is a diagram illustrating a situation in which a through-hole is formed in the predetermined region of the flange with a punch.

FIG. 6A is a diagram illustrating a situation in which the protrusion is inserted into the through-hole.

FIG. 6B is a diagram illustrating a situation in which the leading end of the protrusion is welded to the flange at a contact part.

FIG. 7 is a part perspective view of a sub frame according to a first modification.

FIG. 8 is a partially cross-sectional view of a roof side rail, a side frame, a roof frame, and a plate according to a second modification.

FIG. 9A is an enlarged plan view of a sub frame according to a third modification.

FIG. 9B is a cross-sectional view taken along line IX-IX in FIG. 9A.

FIG. 10 is a diagram illustrating a situation in which the leading ends of a plurality of protrusions according to a fourth modification are welded to a flange at contact parts.

FIG. 11 is a part cross-sectional view of a sub frame according to a fifth modification.

### EMBODIMENTS OF THE INVENTION

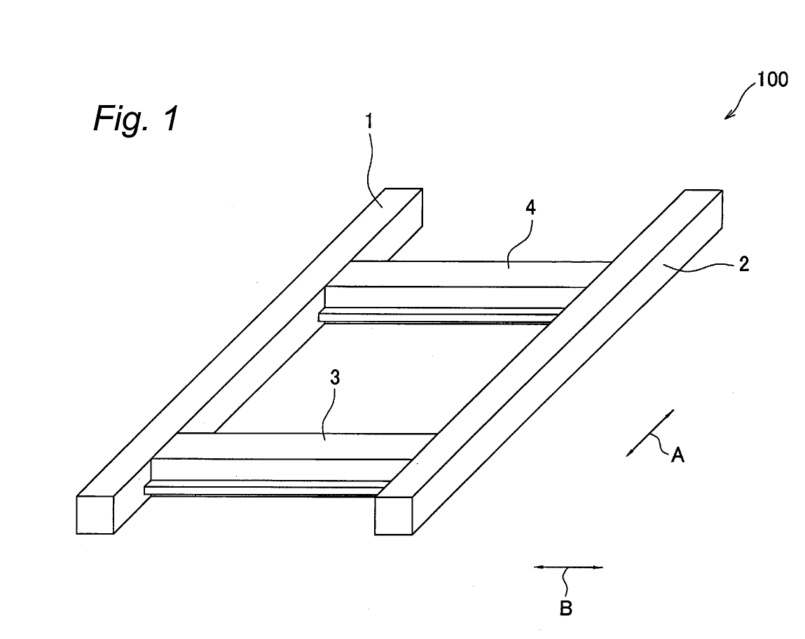

A frame structural body 100 in which a sub frame (different-material bonded body) manufactured by a manufacturing method according to one embodiment of the present invention is employed will be described below with reference to FIGS. 1 to 3.

The frame structural body 100 in the present embodiment is a member that supports, for example, an engine or a decelerator of a vehicle such as an automobile and to which, for example, an underbody support component is attached. As illustrated in FIG. 1, the frame structural body 100 includes a pair of side frames 1 and 2 extending in a front-back direction A, and sub frames 3 and 4 extending in a right-left direction B and connecting the pair of side frames 1 and 2. The side frames 1 and 2 according to the present embodiment are square pipes made of steel, but are not particularly limited thereto.

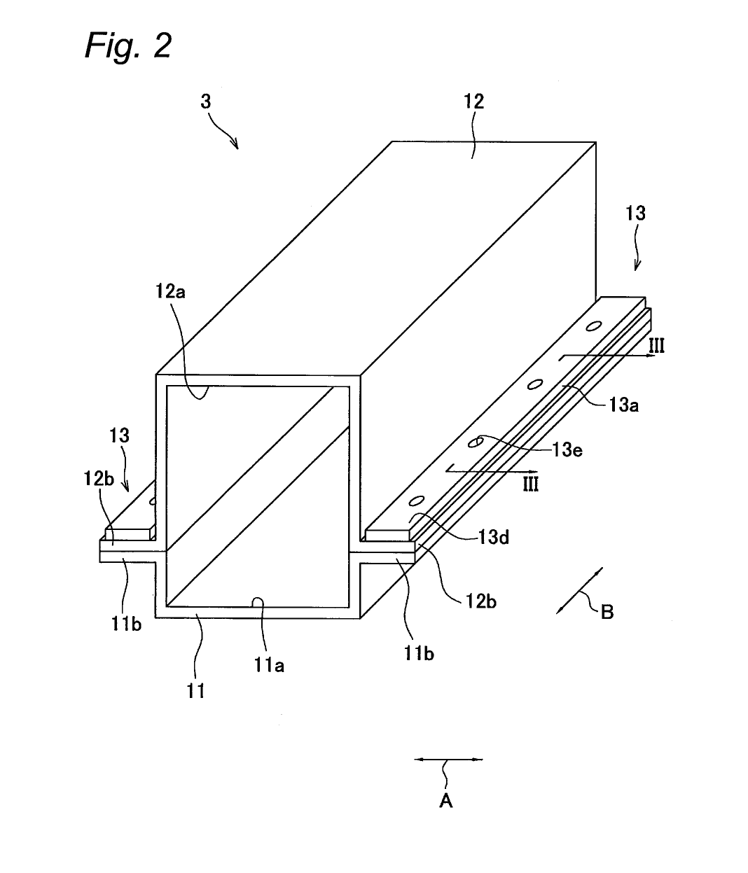

The sub frames 3 and 4 have identical configurations, and thus the sub frame 3 will be described below, whereas description of the sub frame 4 will be omitted. As illustrated in FIG. 2, the sub frame 3 includes a first frame member 11 and a second frame member 12 disposed above the first frame member 11, and has a substantially square pipe shape. The first frame member 11 is obtained by bending a steel plate (Fe alloy plate or Fe plate) so that a recess 11a and a pair of flanges 11b extending in the right-left direction B are formed.

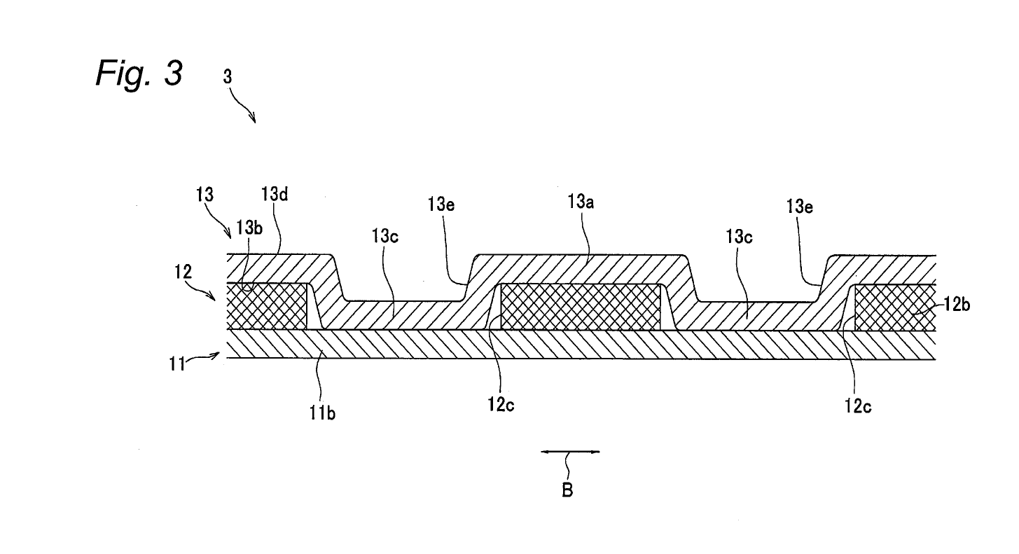

The second frame member 12 is obtained by bending an AL alloy plate (or AL plate) so that a recess 12a and a pair of flanges 12b extending in the right-left direction B are formed. In this manner, the second frame member 12 is made of a material different from that of the first frame member 11. As illustrated in FIG. 3, a plurality of through-holes 12c penetrating in a thickness direction are formed in each flange 12b of the second frame member 12. The plurality of through-holes 12c are disposed at equal intervals along the right-left direction B. Each through-hole 12c has a circular plane shape.

As illustrated in FIG. 2, the sub frame 3 includes a pair of plates 13 disposed on the respective flanges 12b of the second frame member 12. In other words, the plates 13 are disposed at such positions that the plates 13 sandwich the flanges 12b of the second frame member 12 with the flanges 11b of the first frame member 11. Each plate 13 is a steel plate (Fe alloy plate or Fe plate) made of a material same as that of the first frame member 11 and extending long in the right-left direction B. As illustrated in FIG. 3, the plate 13 includes a plate body 13a extending in the right-left direction B, a plurality of protrusions 13c partially protruding from a lower surface 13b of the plate body 13a, and a plurality of holes 13e formed in an upper surface 13d through formation of the protrusions 13c. The plurality of protrusions 13c and the plurality of holes 13e are disposed at positions corresponding to the through-holes 12c of the flanges 12b at equal intervals along the right-left direction B. The plurality of protrusions 13c each have a circular plane shape and a size with which the protrusion 13c can be inserted into the corresponding through-hole 12c. In other words, the diameter of the protrusion 13c is smaller than the diameter of the through-hole 12c. Each protrusion 13c from the lower surface 13b of the plate 13 has a protrusion length with which the protrusion 13c can contact with the flange 11b when the plate 13 is disposed on the flange 12b and that is substantially equal to the thickness of the flange 12b in the present embodiment.

While the plurality of protrusions 13c of the plate 13 are inserted in the through-holes 12c formed in the flange 12b of the second frame member 12, leading ends of the protrusions 13c are welded to the flange 11b of the first frame member 11. Accordingly, the flange 12b of the second frame member 12 is sandwiched between the flange 11b of the first frame member 11 and the plate 13. In this manner, the flanges 11b and 12b as overlapping parts of the first frame member 11 and the second frame member 12 are bonded together, which forms the sub frame 3.

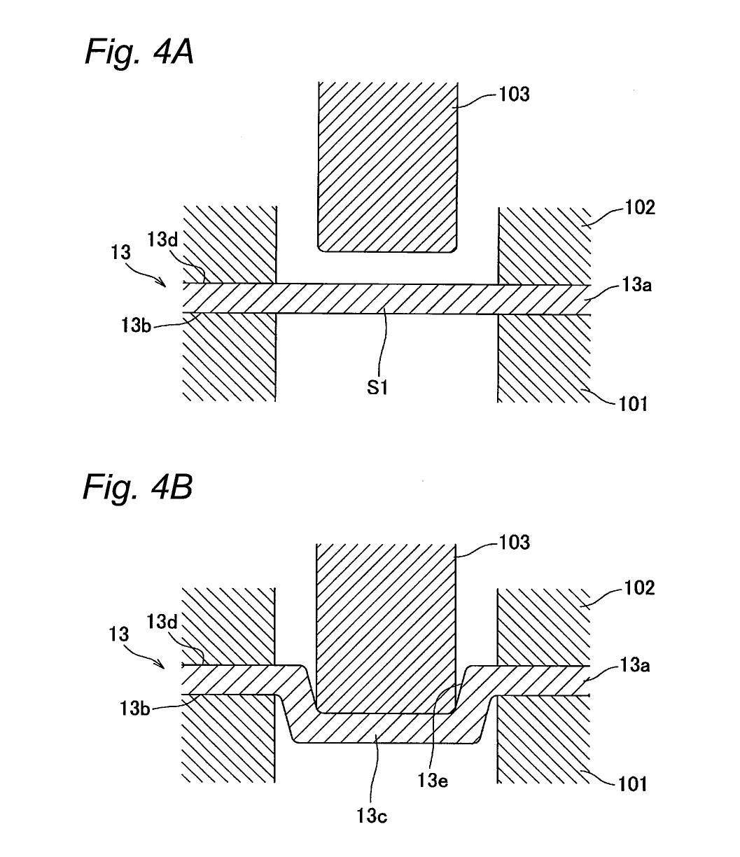

The following describes a method of manufacturing the sub frame 3 with reference to FIGS. 4 to 6. When the sub frame 3 is manufactured, the first frame member 11 and the second frame member 12 made of materials different from each other need to be bonded together. Thus, the method of manufacturing the sub frame 3 includes a method of bonding these different materials. The bonding method in the present embodiment includes a protrusion formation step, a through-hole formation step, a first frame member formation step, a second frame member formation step, a stacking step, and a welding step, which will be described later.

In the manufacturing of the sub frame 3, the protrusions 13c are formed in the plate body 13a by press fabrication (the protrusion formation step) as illustrated in FIG. 4. Specifically, as illustrated in FIG. 4A, the plate body 13a on which the protrusions 13c are yet to be formed is sandwiched between a die 101 and a blank holder 102. The die 101 and the blank holder 102 sandwich the circumference of a predetermined region S1 of the plate body 13a in which each protrusion 13c is to be formed. Thereafter, as illustrated in FIG. 4B, the predetermined region S1 of the plate body 13a is pressed by a cylindrical punch 103. Accordingly, the protrusion 13c is formed in the plate 13. Simultaneously, each hole 13e recessed through the formation of the protrusion 13c is formed in the upper surface 13d of the plate body 13a. This step is repeated to form the plurality of holes 13e together with the plurality of protrusions 13c on the plate 13. In the protrusion formation step, the plurality of protrusions 13c and the plurality of holes 13e may be formed all at once by a plurality of punches 103. In this case, too, the circumference of the predetermined region S1 of the plate body 13a in which each protrusion 13c is to be formed is preferably sandwiched between the die 101 and the blank holder 102. When the plurality of protrusions 13c are formed in the plate 13 through this protrusion formation step, wrinkles are hardly formed in the plate body 13a. As a result, sputtering is unlikely to occur in the welding step to be described later.

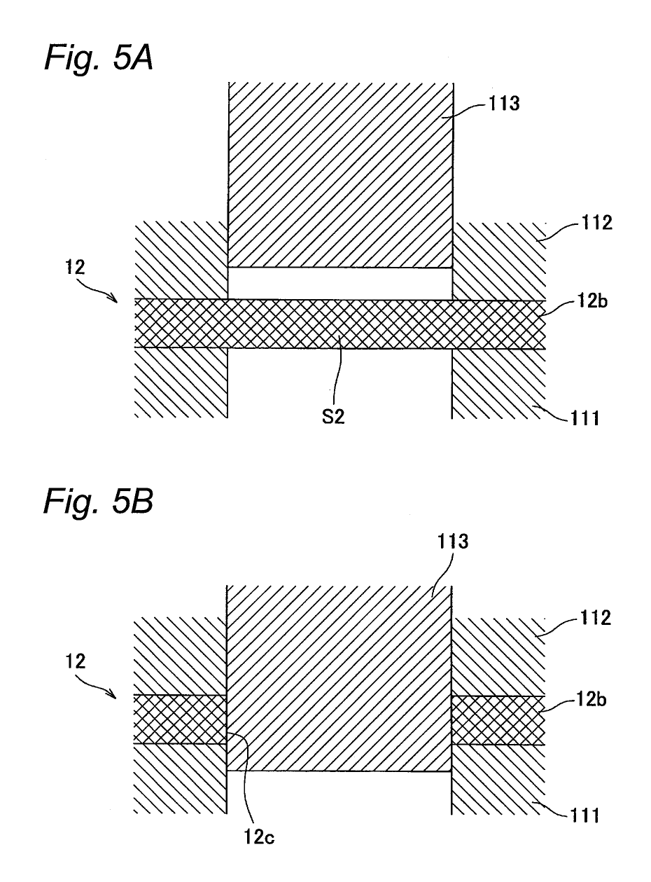

In the manufacturing of the sub frame 3, as illustrated in FIGS. 5A and 5B, the plurality of through-holes 12c are formed, by press fabrication, at parts of an AL alloy plate as the second frame member 12 on which the recess 12a and the pair of flanges 12b are yet to be formed, the parts corresponding to the flanges 12b (the through-hole formation step). Specifically, as illustrated in FIG. 5A, each part of the AL alloy plate that corresponds to the flange 12b is sandwiched between a die 111 and a blank holder 112. The die 111 and the blank holder 112 sandwich the circumference of a predetermined region S2 in which each through-hole 12c of the flange 12b is to be formed. Thereafter, as illustrated in FIG. 5B, the predetermined region S2 of the part corresponding to the flange 12b is punched by a cylindrical punch 114. The punch 114 has a diameter slightly larger than the diameter of the punch 103 used to form each protrusion 13c. In this manner, the through-hole 12c having a diameter larger than that of the protrusion 13c is formed in the part corresponding to the flange 12b. This forms the through-hole 12c into which the protrusion 13c can be inserted in the stacking step to be described later. This step is repeated to form the plurality of through-holes 12c in each part corresponding to the flange 12b of the second frame member 12. In the through-hole formation step, the plurality of through-holes 12c may be formed all at once by a plurality of punches 114. In this case, too, the circumference of the predetermined region S2 of each part corresponding to the flange 12b in which the through-holes 12c are to be formed is preferably sandwiched between the die 111 and the blank holder 112. Even when the plurality of through-holes 12c are formed in each part corresponding to the flange 12b through this through-hole formation step, burrs are hardly formed in the part corresponding to the flange 12b. As a result, the protrusions 13c can be welded to the first frame member 11 while the flanges 11b and 12b and the plate 13 are stacked without a gap therebetween in the stacking step to be described later. Accordingly, the flanges 11b and 12b are further solidly bonded together at each overlapping part. The through-hole formation step may be performed at any timing, for example, before, after, or simultaneously with the protrusion formation step.

After the through-hole formation step, the AL alloy plate on which the plurality of through-holes 12c are formed is bent to form the recess 12a and the pair of flanges 12b. Accordingly, the second frame member 12 is formed (the second frame member formation step).

The steel plate of the first frame member 11 is bent to form the recess 11a and the pair of flanges 11b. Accordingly, the first frame member 11 is formed (the first frame member formation step). The first frame member formation step may be performed before the stacking step to be described later.

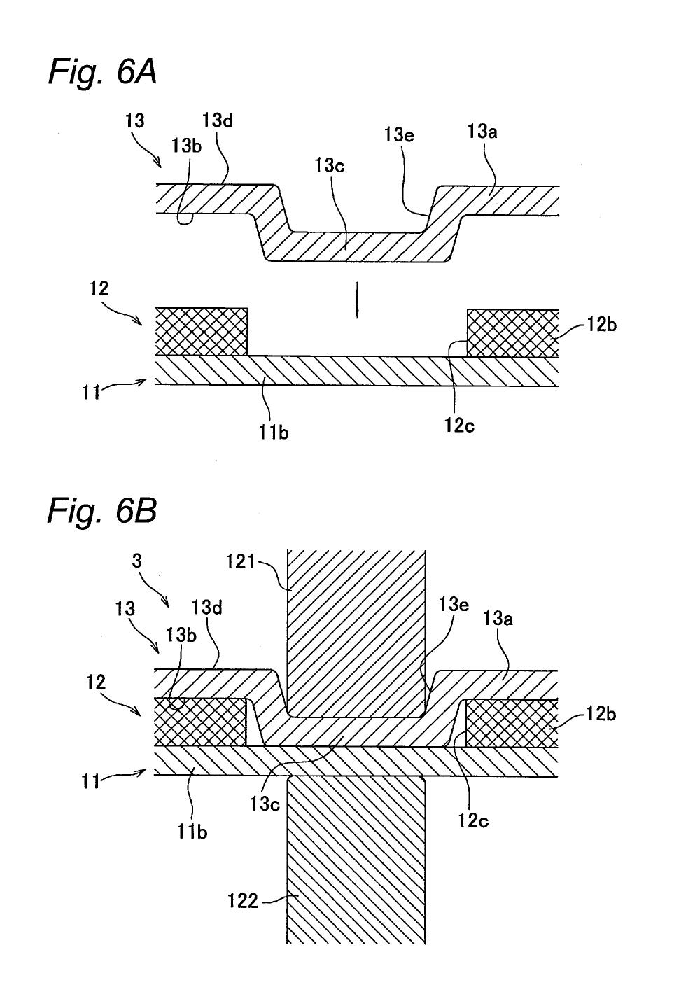

After the protrusion formation step and the first and second frame member formation steps, as illustrated in FIG. 6A, the flanges 11b and 12b are placed over each other by stacking each flange 12b of the second frame member 12 on the corresponding flange 11b of the first frame member 11. Thereafter, as illustrated in FIG. 6B, the plate 13 is stacked on each flange 12b. In other words, the flanges 11b and 12b and the plate 13 are stacked so that the flange 12b is disposed between the flange 11b and the plate 13 (the stacking step). In this case, the protrusions 13c of the plate 13 are inserted into the plurality of respective through-holes 12c of the flange 12b so that the leading ends of the protrusions 13c contact with the flange 11b.

After the stacking step, this stack body of the flanges 11b and 12b and the plate 13 is sandwiched between a pair of cylindrical electrodes 121 and 122 of a known spot welding machine as illustrated in FIG. 6B. In this case, the electrode 121 is disposed in the holes 13e so that the electrode 121 faces to the corresponding protrusion 13c, and the electrode 122 is disposed facing to a region of the flange 11b facing to the protrusion 13c. Then, welding current is applied between the pair of electrodes 121 and 122 while the stack body is pressurized in a stacking direction (the up-down direction in FIGS. 6A and 6B) by the pair of electrodes 121 and 122. In other words, welding current is applied between the pair of electrodes 121 and 122 while the protrusion 13c and the region of the flange 11b facing to the protrusions 13c are sandwiched between the pair of electrodes 121 and 122 so that the protrusion 13c is pressed against the flange 11b (the welding step). Accordingly, the leading end of the protrusion 13c and the flange 11b are bonded together as a contact part therebetween melts. This step is repeated to weld the plurality of protrusions 13c of the plate 13 to the flange 11b. The plurality of protrusions 13c may be welded all at once to the flange 11b by a plurality of pairs of electrodes 121 and 122. In this manner, the flange 12b and the flange 11b are bonded together at each overlapping part between the plate 13 and the flange 11b, which completes the manufacturing of the sub frame 3.

According to the method of manufacturing the sub frame 3 and the method of bonding the first frame member 11 and the second frame member 12 at each overlapping part described above, each plate 13 is welded to the corresponding flange 11b of the first frame member 11 through the protrusions 13c while the corresponding flange 12b of the second frame member 12 is sandwiched between the plate 13 and the flange 11b. The sub frames 3 and 4 (different-material bonded bodies) are manufactured in this manner in each of which the first frame member 11 and the second frame member 12 made of materials different from each other are bonded together at each overlapping part (in other words, each overlapping part between the pair of flanges 11b and 12b). Since the protrusions 13c are formed in advance through the protrusion formation step in the manufacturing method and the bonding method, wrinkles are unlikely to be formed in the plate 13 at protrusion formation. Accordingly, sputtering is unlikely to occur at spot welding of the protrusions 13c to the flange 11b, which leads to improved welding quality and improved bonding strength. Since the protrusions 13c are welded to the flange 11b by applying welding current from the pair of electrodes 121 and 122 while the protrusions 13c formed in the plate 13 in advance are in contact with the flange 11b, the protrusions 13c do not need to be formed by the electrode 121 disposed on a side closer to the protrusions 13c, which leads to a longer lifetime of the electrode 121. Since the protrusions 13c are formed by the dedicated punch 103 instead of the electrode 121, error is unlikely to occur in shaping of the protrusions 13c, which leads to stabilization of the welding quality. Since the welding quality is improved and stabilized in this manner, the bonding strength of each flange 11b of the first frame member 11 and the corresponding flange 12b of the second frame member 12, which are made of materials different from each other, at each overlapping part therebetween is improved and stabilized, which leads to a longer lifetime of the electrode 121.

In the method of manufacturing the sub frame 3 and the bonding method, the through-hole formation step is performed to form, in the pair of flanges 12b of the second frame member 12, the plurality of through-holes 12c into which the protrusions 13c are to be inserted in the stacking step. Accordingly, the plates 13 are welded to the flanges 11b while the protrusions 13c of the plates 13 are inserted in the through-holes 12c of the flanges 12b. As a result, each flange 11b of the first frame member 11 and the corresponding flange 12b of the second frame member 12, which are made of materials different from each other, are more solidly bonded together at each overlapping part therebetween.

In the welding step, spot welding of each protrusion 13c to the corresponding flange 11b is achieved by applying welding current between the pair of electrodes 121 and 122 while the protrusion 13c and a region of the corresponding flange 11b facing to the protrusion 13c are sandwiched between the pair of electrodes 121 and 122. Accordingly, the quality of welding of the protrusion 13c of the plate 13 to the flange 11b is further improved.

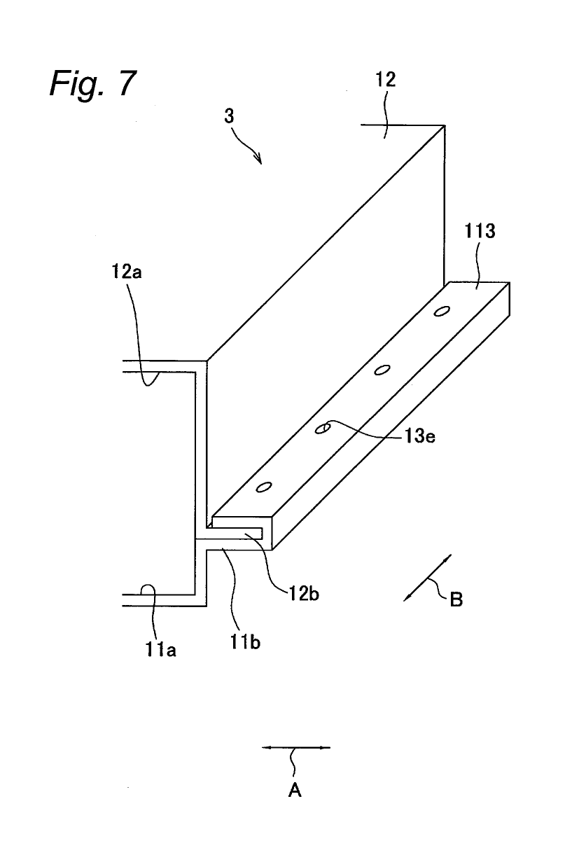

In the sub frame 3 according to the above-described embodiment, each flange 11b of the first frame member 11 and the corresponding flange 12b of the second frame member 12 are bonded together at each overlapping part therebetween by using the plate 13 different from these members. However, a holding part 113 serving as the plate 13 may be integrally formed on the flange 11b. As illustrated in FIG. 7, the holding part 113 formed by bending back the steel plate of the first frame member 11 is provided at an end part of the flange 11b of the first frame member 11 according to this first modification. The holding part 113 is disposed at such a position that the flange 12b is sandwiched between the holding part 113 and the flange 11b. The holding part 113 is equivalent to the plate 13 integrally connected with the flange 11b at an end part extending in the right-left direction B.

The method of manufacturing the sub frame 3 and the bonding method according to the first modification are substantially the same as those of the above-described embodiment although the protrusion formation step, the first frame member formation step, and the stacking step are slightly different from those described above. Specifically, in the protrusion formation step, similarly to the plate 13 described above, the protrusions 13c are formed in a part of the steel plate of the first frame member 11, which corresponds to each holding part 113, by press fabrication. In the first frame member formation step, the steel plate of the first frame member 11 on which the plurality of protrusions 13c and the plurality of holes 13e are formed are bent to form the recess 11a and the pair of flanges 11b. In this step, the part corresponding to each holding part 113 is not bent but disposed flush with the corresponding flange 11b. In the stacking step, each flange 12b of the second frame member 12 and the corresponding flange 11b of the first frame member 11 are placed over by stacking the flange 12b on the flange 11b. Thereafter, as illustrated in FIG. 7, the part of the steel plate of the first frame member 11, which corresponds to the holding part 113 is bent so that the flange 12b is sandwiched between the holding part 113 and the flange 11b. Accordingly, the holding part 113 and the flanges 11b and 12b are stacked. In this case, the protrusions 13c of the holding part 113 are inserted into the plurality of respective through-holes 12c of the flange 12b so that the leading ends of the protrusions 13c contact with the flange 11b. Then, similarly to the above-described embodiment, the welding step is performed to join the flange 12b and the flange 11b together at each overlapping part between the holding part 113 and the flange 11b, which completes the manufacturing of the sub frame 3.

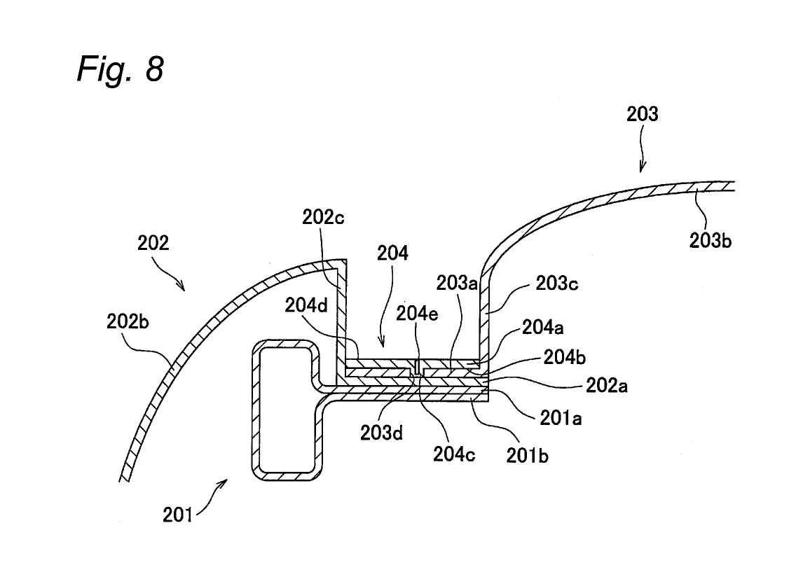

The above-described bonding method is applicable to any frame other than the sub frame 3. As illustrated in FIG. 8, for example, a side frame 202 bonded to a rail roof side 201 included in a vehicle body side part frame of an automobile can be bonded with a roof frame 203 made of a material different from that of the side frame 202 at an overlapping part therebetween. The rail roof side 201 has a section closed with a steel plate (Fe alloy plate or Fe plate) and is formed by placing an upper flange 201a over a lower flange 201b in an up-down direction and welding these flanges.

The side frame 202 is formed by bending a steel plate (Fe alloy plate or Fe plate) and disposed on an outer side of the rail roof side 201. The side frame 202 includes a flange 202a, a curved part 202b, and a connection part 202c connecting the flange 202a and the curved part 202b. The flange 202a is placed over and welded to the flange 201a of the rail roof side 201 in the up-down direction.

The roof frame 203 is formed by bending an AL alloy plate (or AL plate). The roof frame 203 includes a flange 203a, a curved roof part 203b, and a connection part 203c connecting the flange 203a and the roof part 203b. The flange 203a is placed over and bonded with the flange 202a in the up-down direction. A through-hole 203d penetrating in a thickness direction (the up-down direction) is formed in the flange 203a. The through-hole 203d has a circular plane shape.

A plate 204 is stacked on the flange 203a of the roof frame 203. The plate 204 is made of a steel plate (Fe alloy plate or Fe plate) made of a material same as that of the side frame 202, and extends in the vertical direction in FIG. 8. The plate 204 includes a plate body 204a, a protrusion 204c partially protruding a lower surface 204b of the plate body 204a, and a hole 204e formed in an upper surface 204d through formation of the protrusion 204c. The protrusion 204c and the hole 204e are disposed at a position facing to the through-hole 202d of the flange 202a. The protrusion 204c has a circular plane shape and a size that allows insertion into the through-hole 203d. In other words, the diameter of the protrusion 204c is smaller than the diameter of the through-hole 203d. The protrusion 204c from the lower surface 204b of the plate 204 has a protrusion length with which the protrusion 204c can contact with the flange 202a when the plate 204 is disposed on the flange 203a and that is substantially equal to the thickness of the flange 203a in the present modification.

While the protrusion 204c is inserted in the through-hole 203d, a leading end of the protrusion 204c of the plate 204 is welded to the flange 202a. Accordingly, the flange 203a of the roof frame 203 is sandwiched between the flange 202a of the side frame 202 and the plate 204. In this manner, the flanges 202a and 203a at an overlapping part of the side frame 202 and the roof frame 203 are bonded together.

A method of bonding the side frame 202 and the roof frame 203 is substantially the same as the method according to the above-described embodiment. Specifically, in the protrusion formation step, similarly to the above-described embodiment, the protrusion 204c is formed in the plate body 204a by press fabrication. In the through-hole formation step, similarly to the above-described embodiment, the through-hole 203d is formed at part of the AL alloy plate of the roof frame 203, which corresponds to the flange 203a, by press fabrication. After the through-hole formation step, the AL alloy plate is bent to form the roof frame 203 (a roof frame formation step). The steel plate of the side frame 202 is bent to form the side frame 202 (a side frame formation step).

After the protrusion formation step, the roof frame formation step, and the side frame formation step, the flange 203a of the roof frame 203 is placed over on the flange 202a of the side frame 202 by stacking the flange 203a on the flange 202a. Thereafter, the plate 204 is stacked on the flange 203a. In other words, the flanges 202a and 203a and the plate 204 are stacked so that the flange 203a is disposed between the flange 202a and the plate 204 (a stacking step). In this case, the protrusion 204c of the plate 204 is inserted into the through-hole 203d of the flange 203a so that the leading end of the protrusion 204c contacts with the flange 202a. Thereafter, similarly to the above-described embodiment, this stack body of the flanges 202a and 203a and the plate 204 is sandwiched between a pair of electrodes. Specifically, welding current is applied between the pair of electrodes while the protrusion 204c and a region of the flange 202a facing to the protrusion 204c are sandwiched between the pair of electrodes so that the protrusion 204c is pressed against the flange 202a (a welding step). Accordingly, the leading end of the protrusion 204c and the flange 202a are bonded together as a contact part therebetween melts. In this manner, the flange 203a and the flange 202a are bonded together at an overlapping part between the plate 204 and the flange 202a. Thereafter, the rail roof side 201 is bonded with the side frame 202 bonded with the roof frame 203 by welding the flange 201a of the rail roof side 201 to the flange 202a.

In this second modification, too, the same effect can be obtained in a part similarly to that of the above-described embodiment.

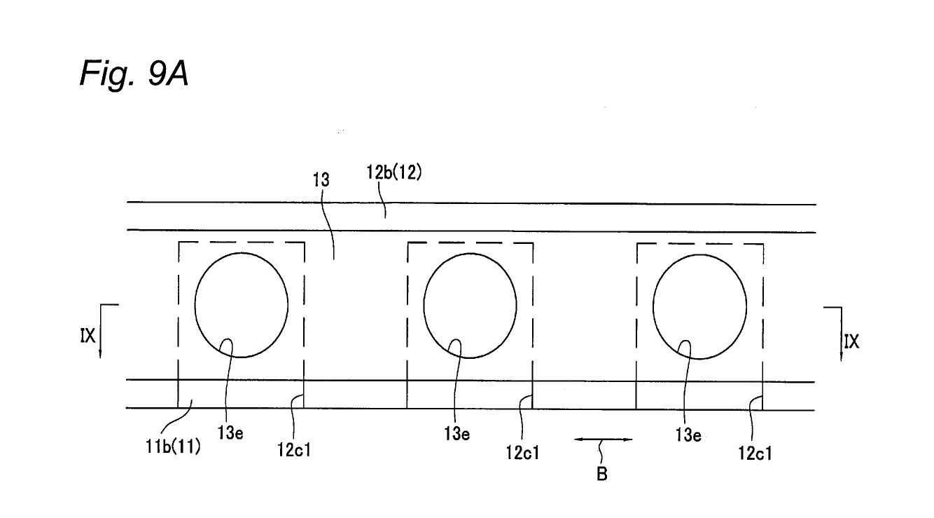

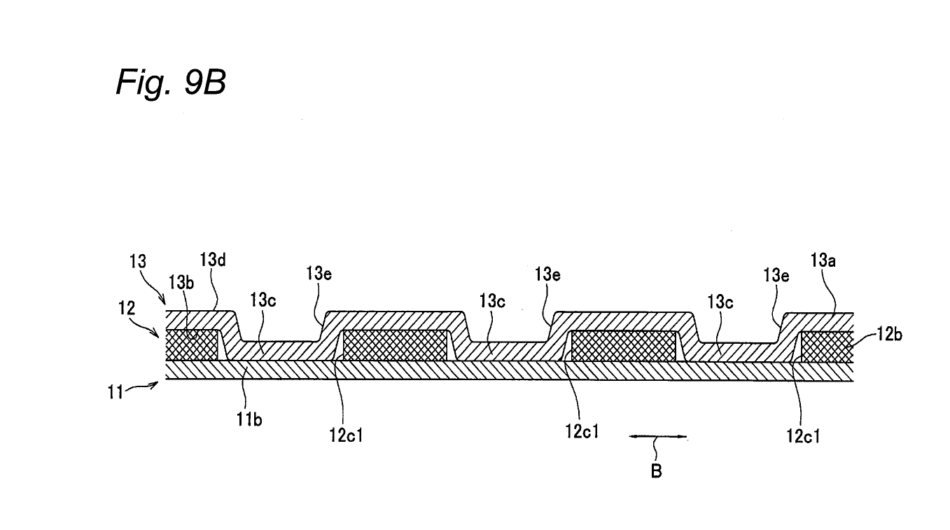

In the above-described embodiment, the through-holes 12c into which the protrusions 13c are inserted are formed in each flange 12b. However, as illustrated in FIG. 9A, cutouts 12c1 may be formed in place of the through-holes 12c in the flange 12b. The cutouts 12c1 are open toward an outer side (the lower side in FIG. 9A) in a direction orthogonal to the right-left direction B. In the method of bonding the first frame member 11 and the second frame member 12 according to this third modification, the through-hole formation step may be replaced with a cutout formation step of forming, in place of the through-holes 12c, the cutouts 12c1 in each flange 12b by press fabrication. Then, in the stacking step, as illustrated in FIG. 9B, the plate 13 and the flanges 11b and 12b are stacked by inserting the protrusions 13c into the cutouts 12c1. Thereafter, the welding step same as that in the above-described embodiment is performed to join the first frame member 11 and the second frame member 12, thereby achieving effects same as those described above.

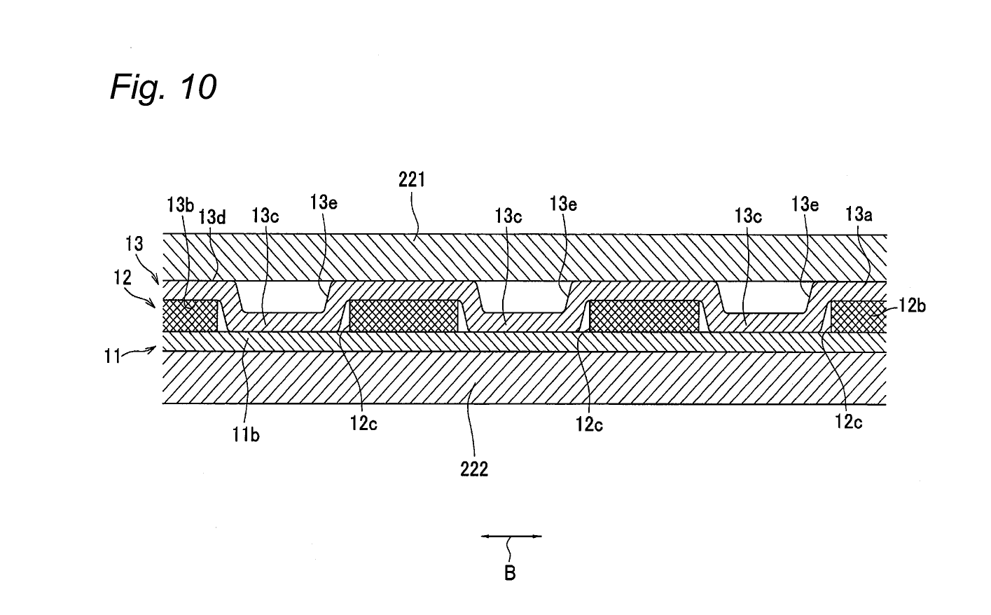

In the welding step according to the above-described embodiment, the protrusions 13c are welded to the corresponding flange 11b one by one while the protrusion 13c and a region of the flange 11b facing to the protrusion 13c are sandwiched between the pair of electrodes 121 and 122, but the plurality of protrusions 13c may be welded all at once to the flange 11b. In this fourth modification, as illustrated in FIG. 10, a pair of electrodes 221 and 222 extending in the right-left direction B are employed so as to be capable of sandwiching the plurality of protrusions 13c and a plurality of regions of the flange 11b facing to the protrusions 13c. Then, welding current is applied between the pair of electrodes 221 and 222 while the plurality of protrusions 13c and the plurality of regions of the flange 11b facing to the protrusions 13c are sandwiched between the pair of electrodes 221 and 222 so that the plurality of protrusions 13c are pressed against the flange 11b. Accordingly, the plurality of protrusions 13c can be effectively welded to the flange 11b as contact parts between the leading ends of the plurality of protrusions 13c and the flange 11b melt.

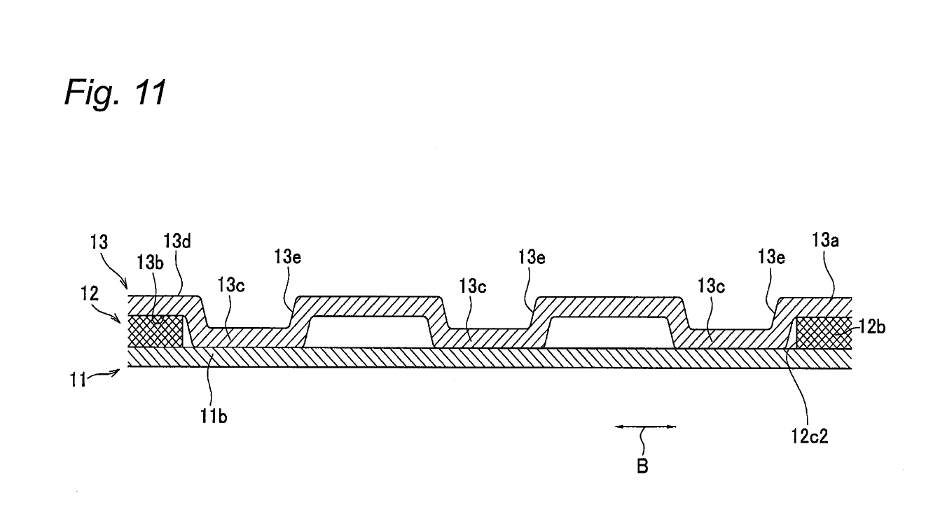

In the above-described embodiment, the plurality of through-holes 12c into which the respective protrusions 13c can be inserted are formed in each flange 12b. However, as illustrated in FIG. 11, a through-hole 12c2 having a size that allows insertion of the plurality of protrusions 13c may be formed in the flange 12b. The through-hole 12c2 has a long hole shape elongated along the right-left direction B. In the method of bonding the first frame member 11 and the second frame member 12 according to this fifth modification, the through-hole 12c2 may be formed in the flange 12b by press fabrication through the through-hole formation step in place of the through-holes 12c. Then, in the stacking step, as illustrated in FIG. 11, the plurality of protrusions 13c are inserted into the through-hole 12c2 and the plate 13 and the flanges 11b and 12b are stacked. Thereafter, the welding step same as that in the above-described embodiment is performed to join the first frame member 11 and the second frame member 12, thereby achieving effects same as those described above. Each cutout 12c1 according to the third modification may have an elongated shape like the through-hole 12c2 so that, in the stacking step, the plurality of protrusions 13c are inserted into the cutout, and the plates 13 and the flanges 11b and 12b may be stacked.

The region of the flange 11b facing to each protrusion 13c is flat in the above-described embodiment. However, a protrusion toward the protrusion 13c may be formed in the region of the flange 11b. This eliminates the need to only increase the protrusion length of the protrusion 13c of the plate 13 even when the flange 12b has a large thickness, which makes it easier to form the protrusion 13c.

Although preferable embodiments of the present invention are described above, the present invention is not limited to the above-described embodiments, and various changes can be made without departing from the scope of the claims. The bonding method and the manufacturing method according to the above-described embodiments and modifications may be employed to join a first metal member and a second metal member made of a material different from that of the first metal member at an overlapping part therebetween. In other words, the bonding method and the manufacturing method are not limited to the above-described manufacturing of the sub frames 3 and 4 and the like, but may be employed to join metal members different from each other.

In the above-described embodiment, the first frame member 11 is made of Fe alloy or Fe but may be made of aluminum alloy or aluminum. In this case, the plate 13 may be made of aluminum alloy or aluminum, and the second frame member 12 may be made of, for example, Fe alloy or Fe. The first frame member 11 and the plate 13 may be made of any metal as long as they are made of metal of the same material, which allows welding therebetween. The second frame member 12 may be made of any metal different from those of the first frame member 11 and the plate 13.

Although the bonding method according to the embodiment or modification described above includes the through-hole formation step or the cutout formation step, the through-hole formation step or the cutout formation step does not need to be included. Specifically, the flange 12b may be simply disposed between the flange 11b and the plate 13 while the protrusions 13c are not inserted into the through-holes 12c in the stacking step, and the protrusions 13c may be welded to the flange 11b in the welding step so that the flanges 11b and 12b are bonded together at each overlapping part while the flange 12b is sandwiched between the flange 11b and the plate 13. This configuration can achieve effects same as those described above.

In the through-hole formation step described above, the through-holes 12c and 12c2 are formed by press fabrication, but may be formed by, for example, a drill. The protrusions 13c and 204c and the through-holes 12c, 12c2, and 203d may have polygonal or elliptical plane shapes or may have, for example, a plane shape elongated in one direction.

### DESCRIPTION OF REFERENCE SIGNS

3, 4: Sub frame (different-material bonded body)

11: First frame member (first metal member)

12: Second frame member (second metal member)

12c, 12c2, 203d: Through-hole

13, 204: Plate (third metal member)

13c, 204c: Protrusion

101, 111: Die

102, 112: Blank holder

103, 114: Punch

113: Holding part (third metal member)

121, 122, 221, 222: Electrode

202: Side frame (first metal member)

203: Roof frame (second metal member)

S1, S2: Predetermined region

1. A method of bonding a first metal member and a second metal member made of a material different from a material of the first metal member at an overlapping part, the method comprising:
a protrusion formation step of forming at least one protrusion in a third metal member made of a material same as the material of the first metal member by pressing a predetermined region of at least the third metal member among the first metal member and the third metal member with a punch while circumference of the predetermined region is sandwiched between a die and a blank holder;
a stacking step of producing such a stack body of the first, second, and third metal members that a leading end of the protrusion of the third metal member formed through the protrusion formation step contacts with the first metal member and the second metal member is disposed between the first metal member and the third metal member; and
a welding step of welding the protrusion to the first metal member by applying welding current between a pair of electrodes while the stack body produced through the stacking step is sandwiched between the pair of electrodes in a stacking direction of the stack body so that the protrusion is pressed against the first metal member.

2. The bonding method according to claim 1, further comprising a through-hole formation step of forming, in a predetermined region of the second metal member, at least one through-hole having a size that allows insertion of the at least one protrusion, wherein
in the stacking step, the first, second, and third metal members are stacked while the at least one protrusion is inserted in the through-hole.

3. The bonding method according to claim 2, wherein, in the through-hole formation step, the through-hole is formed by punching the predetermined region of the second metal member with a punch while circumference of the predetermined region is sandwiched between a die and a blank holder.

4. The bonding method according to claim 1, wherein, in the welding step, welding current is applied between the pair of electrodes while the protrusion and a region of the first metal member facing to the protrusion are sandwiched between the pair of electrodes.

5. The bonding method according to claim 1, wherein
a plurality of the protrusions are formed in the third metal member in the protrusion formation step, and
welding current is applied between the pair of electrodes while the plurality of the protrusions and regions of the first metal member facing to the plurality of the protrusions are sandwiched between the pair of electrodes in the welding step.

6. A method of manufacturing a different-material bonded body in which a first metal member is placed over and bonded with a second metal member made of a material different from a material of the first metal member, the method comprising:
a protrusion formation step of forming at least one protrusion in a third metal member made of a material same as the material of the first metal member by pressing a predetermined region of at least the third metal member among the first metal member and the third metal member with a punch while circumference of the predetermined region is sandwiched between a die and a blank holder;
a stacking step of producing such a stack body of the first, second, and third metal members that a leading end of the protrusion of the third metal member formed through the protrusion formation step contacts with the first metal member and the second metal member is disposed between the first metal member and the third metal member; and
a welding step of welding the protrusion to the first metal member by applying welding current between a pair of electrodes while the stack body produced through the stacking step is sandwiched between the pair of electrodes in a stacking direction of the stack body so that the protrusion is pressed against the first metal member.

7. The bonding method according to claim 2, wherein, in the welding step, welding current is applied between the pair of electrodes while the protrusion and a region of the first metal member facing to the protrusion are sandwiched between the pair of electrodes.

8. The bonding method according to claim 3, wherein, in the welding step, welding current is applied between the pair of electrodes while the protrusion and a region of the first metal member facing to the protrusion are sandwiched between the pair of electrodes.

9. The bonding method according to claim 2, wherein
a plurality of the protrusions are formed in the third metal member in the protrusion formation step, and
welding current is applied between the pair of electrodes while the plurality of the protrusions and regions of the first metal member facing to the plurality of the protrusions are sandwiched between the pair of electrodes in the welding step.

10. The bonding method according to claim 3, wherein
a plurality of the protrusions are formed in the third metal member in the protrusion formation step, and
welding current is applied between the pair of electrodes while the plurality of the protrusions and regions of the first metal member facing to the plurality of the protrusions are sandwiched between the pair of electrodes in the welding step.
